(19) United States
(12) Patent Application Publication
(10) Pub. No.: US 2020/0312202 A1
(43) Pub. Date: Oct. 1, 2020

(54) BACKLIT DISPLAY WITH A FLEXIBLE ARRAY OF LIGHT-EMITTING ELEMENTS

(71) Applicant: Eric Miller, Wellesley, MA (US)

(72) Inventor: Eric Miller, Wellesley, MA (US)

(21) Appl. No.: 16/799,585

(22) Filed: Feb. 24, 2020

Related U.S. Application Data
(60) Provisional application No. 62/809,972, filed on Feb. 25, 2019.

(51) Int. Cl. G09F 13/22; G09F 13/04; G09F 13/14

(52) U.S. Cl. CPC G09F 13/22; G09F 2013/0468; G09F 13/14; G09F 13/0413

(57) ABSTRACT

A backlit display system includes a display framework and a display fabric. The display frame has an inner perimeter defining a central open space. The display fabric has mutually distinct back and image-display panels supported by the display frame such that at least a portion of the central open space is situated between the back and image-display panels. Removably supported by the display frame within the central open space is an illumination panel fabricated from a flexible material and having opposed rear-facing and front-facing surfaces. The illumination panel supports a plurality of light-emitting elements such that, when selectively energized, the light-emitting elements emit light in a direction from the front-facing surface of the illumination panel toward the image-display panel of the display fabric through which the light passes to illuminate an image defined on the image-display panel. The flexible illumination panel can be rolled or folded for storage or transport.

### PROVISIONAL PRIORITY CLAIM

Priority based on Provisional Application, Ser. No. 62/809,972 filed Feb. 25, 2019, and titled “BACKLIT DISPLAY WITH A FLEXIBLE ARRAY OF LIGHT-EMITTING ELEMENTS” is claimed. Moreover, the entirety of the previous provisional application, including the drawings, is incorporated herein by reference as if set forth fully in the present application.

### BACKGROUND

Backlit displays are widely used for signage, advertising and, increasingly, trade show displays. In general, a backlit display include a light-permeable, image-bearing substrate including an image to be selectively illuminated, a framework for supporting the image-bearing substrate, and a light source situated behind the substrate such that, when the light source is energized, light emitted therefrom impinges upon a rear side of the image-bearing substrate and passes therethrough, thereby illuminating the image for viewing by persons situated forward of a front side of the image-bearing substrate.

One issue with existing backlit displays including light sources aimed directly at the rear side of the image-bearing substrate is that the lighting is uneven. More specifically, so-called “hot spots” representing illumination of relatively greater intensity are readily discernable from the viewing side of the substrate. An unwanted distraction, uneven image illumination detracts from the message-sending power of the displayed image and is therefore a source of frustration for those employing backlit displays for messaging.

Another difficulty associated with backlit displays relates to the inability to break them down for storage and transport in a relatively small volume of space. This is particularly so relative to light sources used to illuminate the image-bearing substrate.

Accordingly, a need exists for a backlit display system that that can be deployed simply and rapidly, evenly illuminates a displayed image, and can be stored in a relatively limited amount of space.

### SUMMARY

Alternative embodiments of a backlit display system (alternatively, “backlit display”) have in common a display fabric and a display framework configured for selectively supporting the display fabric. The display framework includes frame front and rear sides and an outer perimeter and inner perimeter, with the inner perimeter defining a central open space. The display fabric has mutually distinct back and image-display panels and is configured such that, when the display fabric is being supported by and about the display framework, (i) the back panel is adjacent and rearward of the frame rear side, (ii) the image-display panel is adjacent and forward of the frame front side, and (iii) at least a portion of the central open space is situated between the back-lighting and image-display panels.

In addition to removably supporting the display fabric, the display framework also removably supports an illumination panel fabricated from a flexible, tear-resistant material. The illumination panel has opposed rear-facing and front-facing surfaces defined such that, when the illumination panel is supported by the display framework between the back and image-display panels of the display fabric, (a) the front-facing surface faces forwardly toward the image-display panel of the display fabric and (b) the rear-facing surface faces rearwardly toward the back panel of the display fabric. In various alternative versions, a plurality of light-emitting elements is carried by the illumination panel such that, when selectively energized, the light-emitting elements emit light from the front-facing surface of the illumination panel toward the image-display panel of the display fabric. Although the particular form or type of the light-emitting elements is not regarded as central to the novelty of the invention, illustrative examples nevertheless include (i) incandescent bulbs, (ii) light-emitting diodes (i.e., LEDs), and (iii) fluorescent bulbs.

When the display fabric is supported by and about the display framework, the image-display panel has an inside surface facing the central open space and an outside surface facing forwardly of the display framework. The back panel has an interior surface that faces the central open space and an exterior surface facing rearwardly of the display framework. The image-display panel is at least partially light-permeable such that light that is emitted from the light-emitting elements impinges upon the inside surface of the image-display panel and exits through the outside surface of the image-display panel, thereby illuminating an image defined by the image-display panel. In each of various versions, the front-facing surface of the illumination panel is at least partially reflective in order to (i) maximize the proportion of emitted light that impinges upon the image-display panel and (ii) facilitate light mixing and “evening” within the central open space between the illumination panel and the image-display panel before impingement upon the image-display panel.

In an exemplary embodiment, the light-emitting elements are arranged along the front-facing surface of the illumination panel in a manner defining an illumination array. Moreover, the illumination panel includes an illumination panel periphery defined by a first set of mutually opposed edges designated as lateral edges and a second set of mutually opposed edges extending between the lateral edges and designated as top and bottom edges. In at least one version including top, bottom, and lateral edges, the illumination panel is of substantially rectangular configuration and dimensioned to fit within and fill most of the central open space defined by the inner perimeter of the display framework. The illumination array defines at least in part a plurality of lighting-element rows that are mutually spaced apart and parallel, with each lighting-element row including at least two lighting-emitting elements and having a lengthwise extent extending between the lateral edges of the illumination panel.

In each of an illustrative set of alternative versions, the manner in which the light-emitting elements are carried by the illumination panel differs. In some versions, the light-emitting elements are mounted directly to the illumination panel individually. However, in at least one version, the light-emitting elements of each lighting-element row are carried by a lighting-element bar that is rigid relative to the illumination panel. In turn, the lighting-element bars, which define lighting-element rows, are affixed to the illumination panel in a mutually parallel configuration. The use of lighting-element bars provides two readily appreciable advantages: (i) facilitating mounting of a plurality of light-emitting elements to the illumination panel simultaneously during fabrication of the illumination panel and (ii) a backbone or electrical “bus” to which the plural light-emitting elements of a single row defined by a lighting-element bar can be readily electrically connected, thereby obviating the need to provide electrical connection to each light-emitting element individually on the illumination panel.

The use of lighting-element bars in certain back-lighting environments is known (e.g. permanent backlit, rigid “light box” signage). However, the affixation of arrays of light-emitting elements to a flexible, tear-resistant substrate, with or without the inclusion of lighting-element bars, provides advantages not previously realized or realizable. Advantageously, a flexible and tear-resistant illumination panel as defined in association with various embodiments of the present invention is readily and repeatably deployable in environments calling for temporary backlit displays, such as tradeshow exhibits. An illumination panel within the scope of the present invention can be rolled for storage and movement between tradeshow events and unrolled for deployment at site setup. The affixation of the light-emitting elements to the flexible substrate maintains the orderly spacing of the light-emitting elements defining an illumination array, maintains the orientation of the light-emitting elements relative to one another and to the illumination panel, and obviates tangled masses of wire used to selectively energize the light-emitting elements. In various embodiments, at least one of the back panel of the image-display fabric and the substrate of the illumination panel is opaque sufficiently to minimize the visibility of the light-emitting elements, wires, and/or lighting element bars, or shadows of the same, through the back panel.

In each of an illustrative set of embodiments, the display framework is modular. More specifically, the display framework is comprised of a plurality of selectively and mutually joinable frame segments. Each frame segment may include longitudinally opposed segment male and female ends such that longitudinally adjacent first and second frame segments are joined by fitting the segment male end of the first frame segment into the segment female end of the adjoining second frame segment. In at least one version, an assembled frame segment comprises at least two selectively decoupleable frame sub-segments. In still an additional version, the frame sub-segments of a frame segment are mutually linked by a tether which is at least one of flexible and elastic. Although the frame segments and, where applicable, frame sub-segments may be variably configured, in at least some versions, they are of tubular configuration. Moreover, it will be readily appreciated that the frame segments can be fabricated from various alternative materials, metal and plastic being illustrative examples.

Representative embodiments are more completely described and depicted in the following detailed description and the accompanying drawings.

### BRIEF DESCRIPTION OF THE DRAWINGS

FIG. 1 shows a backlit display system including a display framework, a partially cut away image-displaying fabric fitted over the frame, and a plurality of light-emitting elements carried by a flexible and tear-resistant illumination panel for selectively illuminating an image displayed on the fabric;

FIG. 2 depicts an assembled modular display framework for a backlit display system;

FIG. 2A shows modular frame segments of a modular display framework; a first frame segment including frame sub-segments in an assembled state and a second frame segment including frame sub-segments in a disassembled state;

FIG. 3 depicts the a backlit display system similar to that of FIG. 1, but with an alternative illumination array in which rows of light-emitting elements are carried by lighting-element bars that are affixed to—and rigid relative to—the flexible and tear-resistant illumination panel;

FIG. 4A shows a flexible illumination panel in the process of being rolled for storage; and

FIG. 4B shows the illumination panel of FIG. 4A completely rolled for storage.

### DETAILED DESCRIPTION

The following description of variously embodied backlit display systems is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to restrict the maximum scope of the claims. Moreover, among the various depicted embodiments, like reference numbers are used to refer to similar or analogous components.

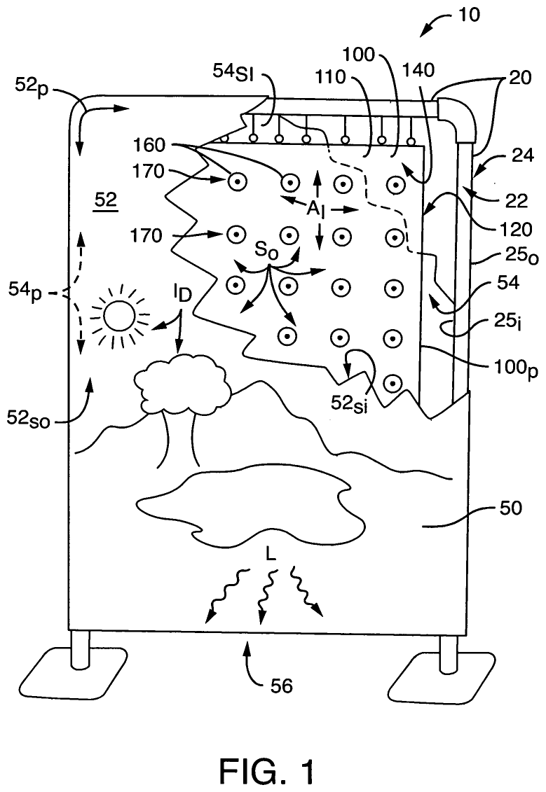

Referring initially to FIG. 1, a first embodiment of a backlit display system 10 (alternatively, backlit display 10) includes a display framework 20 and a display fabric 50 configured for fitting over the framework 20. The display framework 20 has frame front and rear sides 22 and 24 and an outer and inner perimeter 25ₒ and 25ᵢ. The inner perimeter 25ᵢ defines a central open space S_{O}.

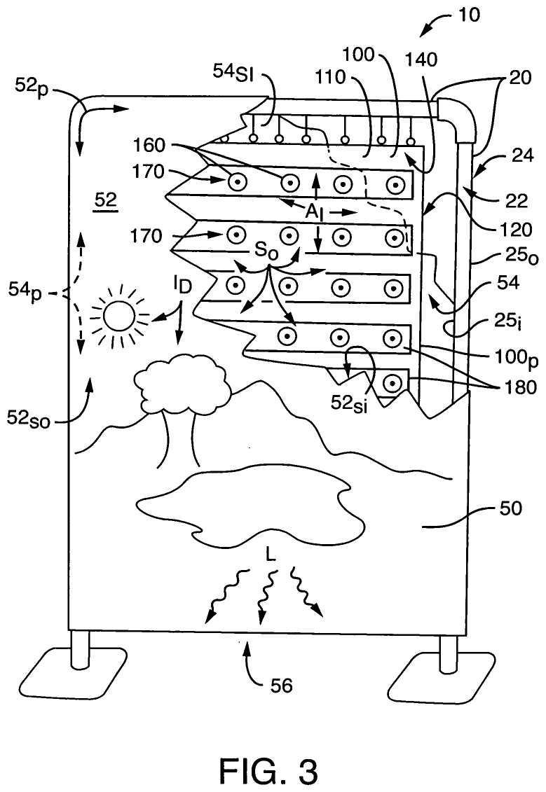

The display fabric 50—cutaway views of which are depicted in FIGS. 1 and 3—has mutually distinct image-display and back panels 52 and 54. The image-display panel 52 defines a displayed image I_{D} (alternatively, image I_{D}) which is, by way of non-limiting example, printed onto the portion of the display fabric 50 constituting the image-display panel 52 or woven of disparately-colored fibers defining the image I_{D}. When the backlit display system 10 is operatively assembled, the display fabric 50 is is supported by and about the display framework 20 such that (i) the back panel 54 is adjacent to and rearward of the frame rear side 24 and the image-display panel 52 is adjacent to and forward of the frame front side 22. Moreover, the image-display and back panels 52 and 54 are mutually opposed with at least a portion of the central open space S_{O} situated between them.

As shown in each of FIGS. 1 and 3, the display framework 20 of the backlit display system 10 also removably supports an illumination panel 100 including a substrate 110 fabricated from a flexible, tear-resistant material, such as a polymeric material, like plastic. The illumination panel 100 has opposed rear-facing and front-facing surfaces 120 and 140 defined such that, when the illumination panel 100 is supported by the display framework 20 between the image-display and back panels 52 and 54 of the display fabric 50, (a) the front-facing surface 140 faces forwardly toward the image-display panel 52 of the display fabric 50 and (b) the rear-facing surface 120 faces rearwardly toward the back panel 54 of the display fabric 50.

Although FIGS. 1 and 3 depict alternatively configured illumination panels 100, in each case, the illumination panel 100 supports a plurality of light-emitting elements 160. When selectively energized, the light-emitting elements 160 emit light L from the front-facing surface 140 of the illumination panel 100. In each of various versions, the front-facing surface 140 of the illumination panel 100 is at least partially reflective.

With the backlit display system 10 thusly assembled, the image-display panel 52 has an inside surface 52_{SI} facing the central open space S_{O} and an outside surface 52_{SO} facing away from the central open space S_{O} and forwardly of the display framework 20. The back panel 54 has an interior surface 54_{SI} that faces the central open space S_{O}. The image-display panel 52 is at least partially light-permeable such that light L that is emitted from the light-emitting elements 160 impinges upon the inside surface 52_{SI} of the image-display panel 52 and exits through the outside surface 52_{SO} of the image-display panel 52. The displayed image I_{D} is thusly illuminated (i.e., backlit) by the passage of light L through the fabric image-display panel 52.

In each of the illustrative embodiments of FIGS. 1 and 3, the light-emitting elements 160 are arranged along the front-facing surface 140 of the illumination panel 100 in a manner defining an illumination array A_{I}. Moreover, the illumination panel 100 includes an illumination panel periphery 100_{P} defined by a first set of mutually opposed edges designated as lateral edges 152 and a second set of mutually opposed edges extending between the lateral edges 152 and designated as bottom and top edges 156 and 158. In each of the versions depicted, the illumination panel 100 is of substantially rectangular configuration and dimensioned to fit within and fill most of the central open space S_{O} defined by the inner perimeter 25ᵢ of the display framework 20. The illumination array A_{I} defines a plurality of lighting-element rows 170 that are mutually spaced apart and parallel, with each lighting-element row 170 including at least two lighting-emitting elements 160 and having a lengthwise extent extending between the lateral edges 152 of the illumination panel 100.

In each of an illustrative set of alternative versions, the manner in which the light-emitting elements 160 are carried by (i.e., secured to) the substrate 110 of the illumination panel 100 differs. In the version of FIG. 1, the light-emitting elements 160 are mounted directly to the illumination panel 100 individually. In the version of FIG. 3, however, the light-emitting elements 160 of each lighting-element row 170 are carried by a lighting-element bar 180 that is rigid relative to the substrate 110 of the illumination panel 100. In turn, the lighting-element bars 180, which define lighting-element rows 170, are affixed to the substrate 110 of the illumination panel 100 in a mutually parallel configuration.

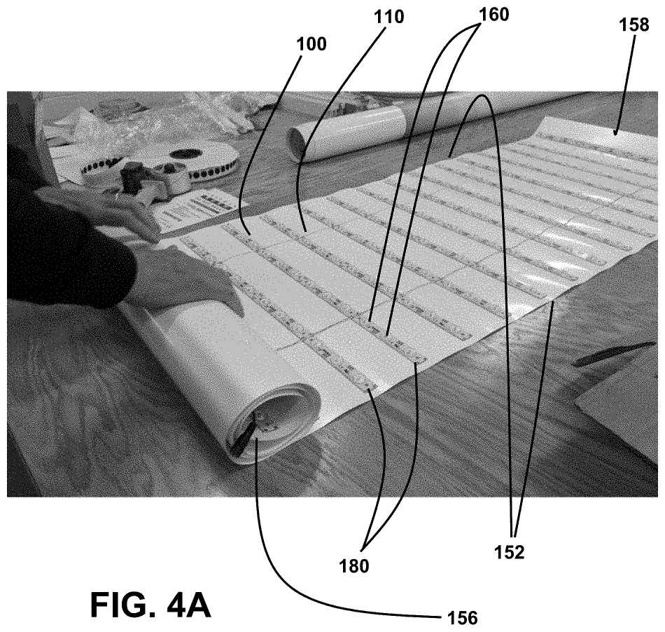

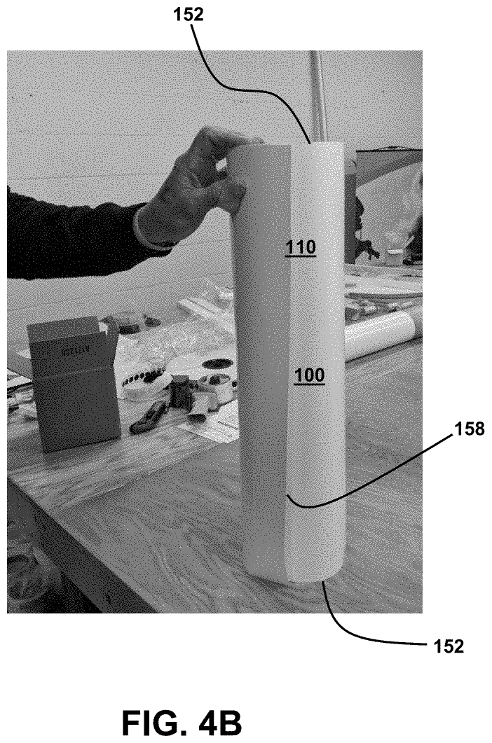

The securement of light-emitting elements 160 to a flexible, tear-resistant substrate 110, with or without the inclusion of lighting-element bars 180, provides various advantages, at least some of which were discussed in the summary section of the present disclosure. One such advantage is discussed in greater detail with reference to FIGS. 4A and 4B, which show the same illumination panel 100 that includes lighting-element bars 180. FIGS. 4A and 4B illustrate how the illumination panel 100 within the scope of the present invention can be rolled for storage and movement between tradeshow events and unrolled for deployment at site setup. The affixation of the light-emitting elements 160 to the flexible substrate 110 maintains the orderly spacing of the light-emitting elements 160 defining an illumination array A_{I}, maintains the orientation of the light-emitting elements 160 relative to one another and to the illumination panel 100, and obviates tangled masses of wire used to selectively energize the light-emitting elements 160. In FIG. 4A, the illumination panel 100 is being rolled bottom edge 156 to top edge 158.

In various embodiments, the display fabric 50 is comprised of “tension fabric.” Tension fabric is somewhat stretchable and exhibits a memory property. Accordingly, a display fabric 50 that is properly sized and configured relative to the display framework 20 is such that—when supported by the display framework 20 in a display-operative mode—at least the image-display panel 52 is taut (e.g., stretched under tension). It will be appreciated that configuring the display fabric 50 and display framework 20 in observance of such parameters facilitates a displayed image I_{D} that is smooth and free of creases and wrinkles. Still additional embodiments are such that both the back and image-display panels 54 and 52 are taut when the display fabric 50 is supported by the display framework 20 in a display-operative mode.

In still more specific versions, the image-display and back panels 52 and 54 are mutually joined along their peripheries so as to define a “slip-cover” having an opening 56 through which the display framework 20 can be introduced. With reference to the illustrative version of FIG. 1, each of the image-display and back-lighting panels 52 and 54 is generally rectangular. The image-display panel 52 is bounded by a display-panel periphery 52_{P}, while the back panel 54 is bounded by a back-panel periphery 54_{P}. The peripheries 52_{P} and 54_{P} are joined to one another along three of four edges in order to define a display fabric 50 that resembles a pillow case. The particular means by which the panel peripheries 52_{P} and 54_{P} are joined is of no direct materiality to the points of novelty, but they could be permanently joined by stitching, for example, or temporarily joinable and separable by snaps or a zipper, by way of non-limiting example.

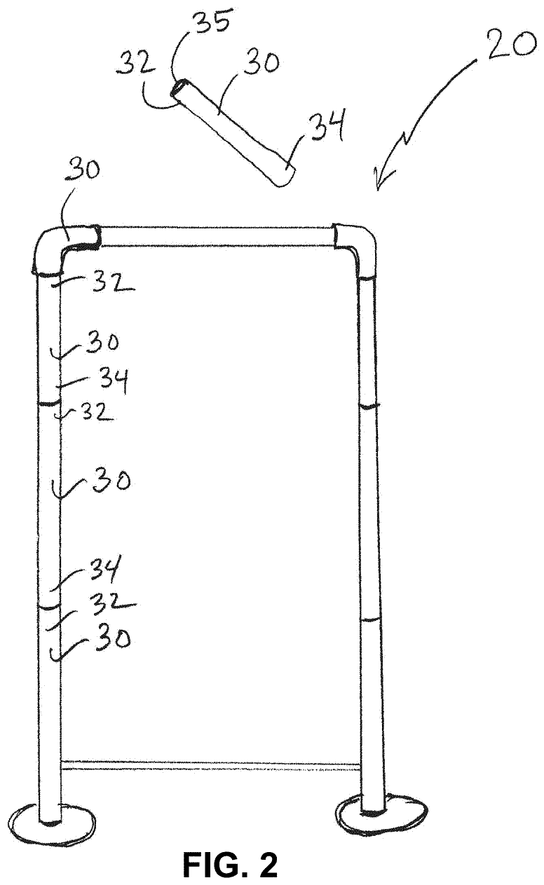

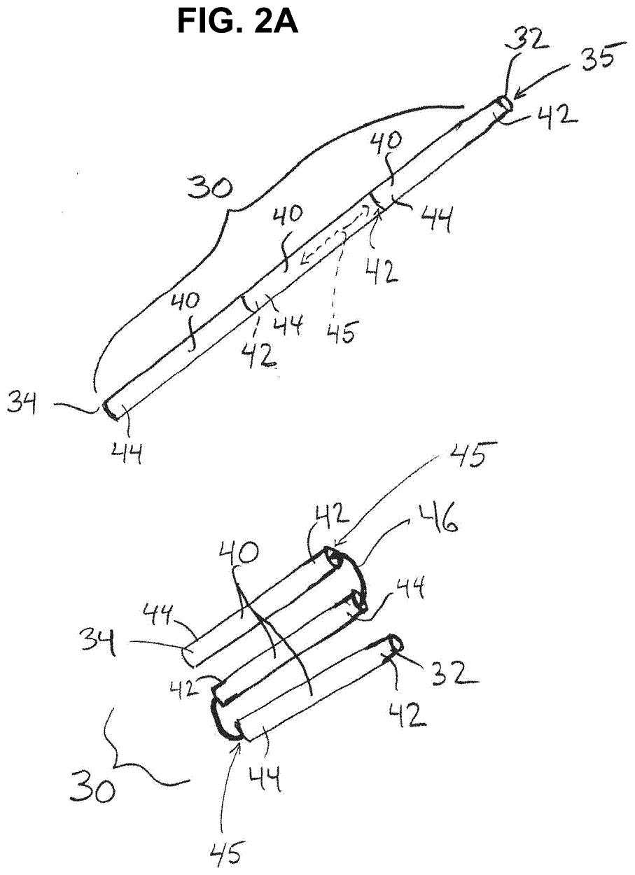

In various embodiments discussed with principal reference to the illustrative version of FIG. 2, the display framework 20 is modular. More specifically, in the version of FIG. 2, the display framework 20 is comprised of a plurality of tubular frame segments 30. Each tubular frame segment 30 includes a segment male end 32 and a segment female end 34 between which ends 32 and 34 there extends a hollow interior segment channel 35. Two adjacent frame segments 30 are joined by fitting the segment male end 32 of a first segment 30 into the segment female end 34 of the adjoining frame segment 30, in very much the same manner in which various types of tent and canopy poles are configured and assembled. Although tubular frame members are frequently cylindrical, tubular frame segments 30 of various alternative cross-sectional geometries are within the scope and contemplation of the invention.

Referring to FIG. 2A, some embodiments include tubular frame segments 30 that are themselves comprised of tubular frame sub-segments 40. Like the frame segments 30 of which they form a part, each frame sub-segment 40 includes a sub-segment male end 42 and a sub-segment female end 44 between which ends 42 and 44 there extends a hollow interior sub-segment channel 45. Two adjacent sub-segments 40 are joined by fitting the sub-segment male end 42 of a first sub-segment 40 into the sub-segment female end 44 of the adjoining frame sub-segment 40. The top portion of FIG. 2A shows an assembled frame segment 30, while the bottom portion of FIG. 2A depicts a disassembled frame segment 30.

It will be readily appreciated that, when at least two frame sub-segments 40 are cooperatively coupled to form an assembled frame segment 30 (top portion of FIG. 2A), the sub-segment male end 42 of the frame sub-segment 40 at one end of the frame segment 30 constitutes the segment male end 32, while the sub-segment female end 44 at the opposite end of the frame segment 30 constitutes the segment female end 34. In various configurations, the frame sub-segments 40 of a frame segment 30 are mutually linked by a flexible tether 46. More specifically, a first end 46A of the tether 46 is joined—within the sub-segment channel 45—to a frame sub-segment 40 at one end of the frame segment 30, while a second end 46B of the tether 46 is joined—within the sub-segment channel 45—to a frame sub-segment 40 at the opposite end of the frame segment 30. Furthermore, the tether 46 passes through the sub-segment channels 45 of all sub-segments 40 by which the frame segment 30 is defined. In addition to being flexible, the tether 46 is preferably elastic in order to accommodate the separation of sub-segments 40, while avoiding slack as the sub-segments 40 are mutually joined.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A backlit display system comprising:
a display framework having frame front and rear sides and an outer perimeter and inner perimeter, the inner perimeter defining a central open space;
a display fabric having mutually distinct back and image-display panels, the display fabric being removably supported by and about the display framework such that (i) the back panel is adjacent and rearward of the frame rear side, (ii) the image-display panel is adjacent and forward of the frame front side, and (iii) at least a portion of the central open space is situated between the back and image-display panels;
an illumination panel fabricated from a flexible, tear-resistant material and having opposed rear-facing and front-facing surfaces, the illumination panel being removably supported by the display framework between the back and image-display panels of the display fabric such that (a) the front-facing surface faces forwardly toward the image-display panel of the display fabric and (b) the rear-facing surface faces rearwardly toward the back panel of the display fabric; and
a plurality of light-emitting elements carried by the illumination panel such that, when selectively energized, the light-emitting elements emit light from the front-facing surface of the illumination panel toward the image-display panel of the display fabric, wherein
(i) the image-display panel has an inside surface facing the central open space and an outside surface facing forwardly of the display framework;
(ii) the front-facing surface of the illumination panel is at least partially reflective; and
(iii) the image-display panel is at least partially light-permeable such that a portion of the light that is emitted from the light-emitting elements impinges upon the inside surface of the image-display panel and exists through the outside surface of the image-display panel, thereby illuminating an image defined by the image-display panel.

2. The backlit display system of claim 1 wherein the light-emitting elements are arranged along the front-facing surface of the illumination panel in a manner defining an illumination array.

3. The backlit display system of claim 2 wherein
(a) the illumination panel includes an illumination panel periphery defined by a first set of mutually opposed edges designated as lateral edges and a second set of mutually opposed edges extending between the lateral edges and designated as top and bottom edges; and
(b) the illumination array defines at least in part a plurality of lighting-element rows that are mutually spaced apart and parallel, each lighting-element row including at least two lighting-emitting elements and having a lengthwise extent extending between the lateral edges of the illumination panel.

4. The backlit display system of claim 3 wherein
(i) the light-emitting elements of each lighting-element row are carried by a lighting-element bar that is rigid relative to the illumination panel; and
(ii) the lighting-element bars are affixed to the illumination panel in a mutually parallel configuration.

5. The backlit display system of claim 1 wherein the display fabric comprises tension fabric sized and configured relative to the display framework such that, when the display fabric is supported by the display framework in a display-operative mode, at least the image-display panel is taut.

6. The backlit display system of claim 5 wherein the image-display and back-lighting panels are mutually joined along peripheries of each so as to define a slip-cover having an opening through which the display framework can be introduced, thereby permitting a user to slip the display fabric over the display framework to render the backlit display system operatively assembled.

7. An illumination panel for use in conjunction with a backlit display system and comprising:
a substrate of flexible, tear-resistant material having opposed rear-facing and front-facing surfaces; and
a plurality of light-emitting elements carried by the illumination panel such that, when selectively energized, the light-emitting elements emit light from the front-facing surface of the illumination panel, wherein at least one of
(i) the front-facing surface of the illumination panel is at least partially reflective; and
(ii) the substrate is opaque.

8. The illumination panel of claim 7 wherein the light-emitting elements are arranged along the front-facing surface in a manner defining an illumination array.

9. The illumination panel of claim 8 wherein
(a) the illumination panel includes an illumination panel periphery defined by a first set of mutually opposed edges designated as lateral edges and a second set of mutually opposed edges extending between the lateral edges and designated as top and bottom edges; and
(b) the illumination array defines at least in part a plurality of lighting-element rows that are mutually spaced apart and parallel, each lighting-element row including at least two lighting-emitting elements and having a lengthwise extent extending between the lateral edges of the illumination panel.

10. The illumination panel of claim 9 wherein
(i) the light-emitting elements of each lighting-element row are carried by a lighting-element bar that is rigid relative to the illumination panel; and
(ii) the lighting-element bars are affixed to the illumination panel in a mutually parallel configuration.

11. The illumination panel of claim 8 wherein
(a) the illumination array defines a plurality of lighting-element rows that are mutually spaced apart and parallel, each lighting-element row including at least two lighting-emitting elements;
(b) the light-emitting elements of each lighting-element row are carried by a lighting-element bar that is rigid relative to the illumination panel; and
(c) the lighting-element bars are affixed to the illumination panel in a mutually parallel configuration.

12. A backlit display system comprising:
a display framework having an inner perimeter defining a central open space;
a display fabric having mutually distinct back and image-display panels supported by and about the display framework such that at least a portion of the central open space is situated between the back and image-display panels; and
a flexible illumination panel having opposed rear-facing and front-facing surfaces, the illumination panel (i) being removably supported by the display framework between the back and image-display panels of the display fabric and (ii) carrying a plurality of light-emitting such that, when selectively energized, the light-emitting elements emit light in a direction from the front-facing surface of the illumination panel toward the image-display panel of the display fabric, thereby illuminating an image defined by the image-display panel.
